(19) United States
(12) Patent Application Publication
(10) Pub. No.: US 2006/0053465 A1
(43) Pub. Date: Mar. 9, 2006

(54) Apparatus and method for providing alert outputs

(76) Inventors: Mark Gilmore Mears, Zionsville, IN (US); Scott Allan Kendall, Westfield, IN (US); Rajeev Madhukar Sahasrabudhe, Fishers, IN (US); Michael Alan Bridge, Noblesville, IN (US)

Correspondence Address: THOMSON LICENSING INC., PATENT OPERATIONS, PO BOX 5312, PRINCETON, NJ, 08543-5312, US

(21) Appl. No.: 10/535,116

(22) PCT Filed: Nov. 13, 2003
(86) PCT No.: PCT/US03/36412

§ 371 Date: May 16, 2005

Related U.S. Application Data
(60) Provisional application No. 60/426,952, filed on Nov. 15, 2002.
(60) Provisional application No. 60/426,954, filed on Nov. 15, 2002.

(51) Int. Cl. H04N 7/173

(52) U.S. Cl. 725/133

(57) ABSTRACT

An apparatus such as a television signal receiver, radio and/or other device having an emergency alert function provides alert outputs in manner which increases the likelihood that users are promptly notified of emergency events. According to an exemplary embodiment, a television signal receiver includes a tuner operative to tune signals including emergency alert signals capable of activating the emergency alert function. A processor is operative to enable a disabled audio output device associated with the television signal receiver responsive to activation of the emergency alert function.

### CROSS REFERENCE TO RELATED APPLICATIONS

This application claims priority to and all benefits accruing from two provisional applications filed in the United States Patent and Trademark Office on Nov. 15, 2002, and there assigned Ser. Nos. 60/426,952 and 60/426,954.

### BACKGROUND OF THE INVENTION

1. Field of the Invention

The present invention generally relates to apparatuses such as television signal receivers and/or other devices having an emergency alert function, and more particularly, to techniques for providing alert outputs using such apparatuses which increase the likelihood that users are notified of emergency events.

2. Background Information

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOM, and provide an emergency alert function using Specific Area Message Encoding (SAME) technology. Apparatuses using SAME technology typically require a user to perform a setup process for the emergency alert function by selecting items such as one or more geographical areas of interest, and one or more types of emergency events which activate the emergency alert function. Once the setup process is complete, the emergency alert function may be activated when incoming emergency alert signals including SAME data indicate the occurrence of an emergency event which corresponds to the geographical area(s) and types of emergency event selected by the user during the setup process. When the emergency alert function is activated, an alert output such as an audio message may be provided to alert individuals of the emergency event.

With apparatuses using technology such as SAME technology, individuals may not be alerted to emergency events in certain instances. For example, an apparatus such as a television signal receiver may include an audio output device such as an internal speaker which is disabled when another audio output device such as an audio receiver and/or amplifier is operatively connected to an audio output terminal (e.g., audio output plug(s)) of the television signal receiver. Moreover, the connected audio output device may not be turned on, or may be turned on but processing audio data from an input source other than the television signal receiver, such as a video cassette recorder (VCR), digital versatile disk (DVD) player, or other device. In such an instance, if the emergency alert function of the television signal receiver is activated, individuals may not be alerted to an emergency event since the audio output device of the television signal receiver is disabled, and therefore unable to provide an alert output. Moreover, the audio output device connected to the television signal receiver will not provide an alert output since it is either turned off, or is processing audio data from an input source other than the television signal receiver. As a result, individuals may not be alerted to an emergency event, and may therefore be exposed to potentially dangerous conditions.

Accordingly, there is a need for an apparatus and method for providing notification of emergency events which avoids the foregoing problems, and thereby increases the likelihood that users are notified of emergency events. The present invention addresses these and other issues.

### SUMMARY OF THE INVENTION

In accordance with an aspect of the present invention, an apparatus having an emergency alert function is disclosed. According to an exemplary embodiment, the apparatus comprises tuning means for tuning signals including emergency alert signals capable of activating the emergency alert function. Processing means are provided for enabling a disabled audio output device associated with the apparatus responsive to activation of the emergency alert function.

In accordance with another aspect of the present invention, a method for controlling an apparatus having an emergency alert function is disclosed. According to an exemplary embodiment, the method comprises steps of tuning signals including emergency alert signals capable of activating the emergency alert function, and enabling a disabled audio output device associated with the apparatus responsive to activation of the emergency alert function.

In accordance with yet another aspect of the present invention, a television signal receiver having an emergency alert function is disclosed. According to an exemplary embodiment, the television signal receiver comprises a tuner operative to tune signals including emergency alert signals capable of activating the emergency alert function. A processor is operative to enable a disabled audio output device associated with the television signal receiver responsive to activation of the emergency alert function.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a block diagram of a television signal receiver according to an exemplary embodiment of the present invention;

FIG. 3 is a flowchart illustrating steps according to an exemplary embodiment of the present invention;

FIG. 4 is a diagram illustrating how an alert output may be provided via a secondary device according to an exemplary embodiment of the present invention;

FIG. 5 is a diagram illustrating how an alert output may be provided via a secondary device according to another exemplary embodiment of the present invention;

FIG. 6 a is diagram illustrating how an alert output may be provided via a secondary device according to still another exemplary embodiment of the present invention; and

FIG. 7 is diagram illustrating how an alert output may be provided via a secondary device according to yet another exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

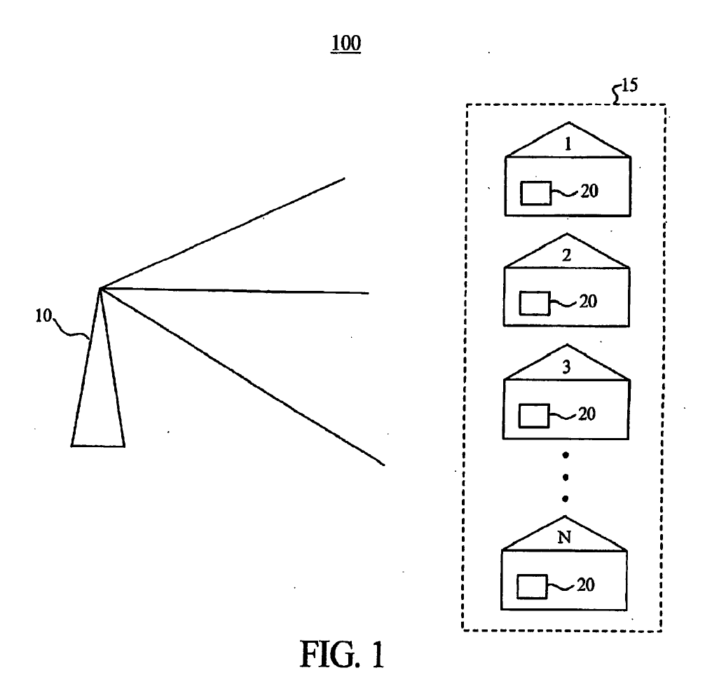

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables television signal receiver 20 to receive emergency alert signals and provide one or more alert outputs to notify individuals of an emergency event. As will be discussed later herein, television signal receiver 20 is also capable of, among other things, enabling a disabled audio output device, such as an internal speaker, before providing an alert output via the audio output device. Television signal receiver 20 is also capable of providing an alert output via one or more secondary devices, such as a telephone, computer, and/or other device, to further increase the likelihood that users are notified of an emergency event. For purposes of example, the present invention will be described herein with reference to television signal receiver 20. However, the principles of the present invention may also be used by other apparatuses, such as radios.

According to an exemplary embodiment, signal transmission source 10 s transmits signals including audio, video and/or emergency alert signals which may be received by each television signal receiver 20. According to an exemplary embodiment, the emergency alert signals may be provided from an authority such as the NWS, or other authorities such as governmental entities or the like. Signal transmission source 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each television signal receiver 20 may provide one or more alert outputs to thereby notify individuals of the emergency event. Signal transmission source 10 may transmit signals to television signal receivers 20 via any wired or wireless link such as, but not limited to, terrestrial, cable, satellite, fiber optic, digital subscriber line (DSL), and/or any other type of broadcast and/or multicast means.

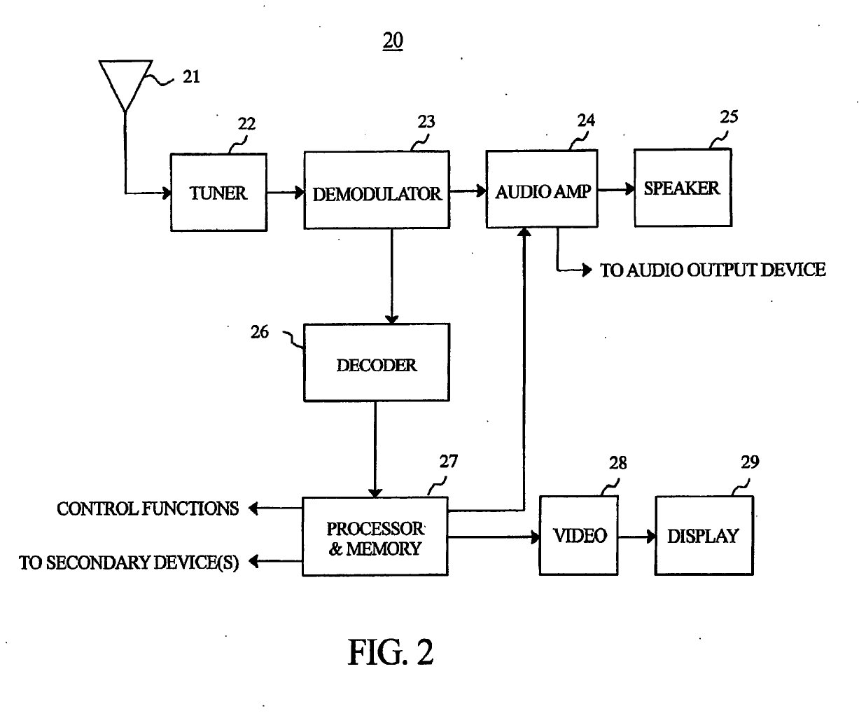

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements of television signal receiver 20 including control signals may not be shown in FIG. 2.

Signal receiving element 21 is operative to receive signals including audio, video and/or emergency alert signals from signal sources,. such as signal transmission source 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

Tuner 22 is operative to tune signals including audio, video and/or emergency alert signals. According to an exemplary embodiment, tuner 22 may be capable of tuning audio signals on at least the following designated NWS frequencies: 162.400 MHz, 162.425 MHz, 162.450 MHz, 162.475 MHz, 162.500 MHz, 162.525 MHz and 162.550 MHz. As previously indicated herein, such audio signals may include digitally encoded emergency alert signals. Tuner 22 may also tune other frequency channels including those used in terrestrial, cable, satellite and/or other transmissions.

Demodulator 23 is operative to demodulate signals provided from tuner 22, and may demodulate signals in analog and/or digital transmission formats. According to an exemplary embodiment, demodulator 23 demodulates audio signals to thereby generate demodulated audio signals representing audio content such as an NWS audio message, a warning alert tone and/or other audio content.

Audio amplifier 24 is operative to amplify the audio signals output from demodulator 23 responsive to one or more control signals provided from processor 27. As indicated in FIG. 2, audio signals may also be provided to an audio output device such as an audio receiver and/or amplifier (not shown) which is operatively connected to television signal receiver 20 via an audio output terminal (e.g., audio output plug(s)). Speaker 25 is operative to aurally output the amplified audio signals provided from audio amplifier 24, and may be embodied as an internal speaker of television signal receiver 20 and/or other audio output device associated with television signal receiver 20.

Decoder 26 is operative to decode signals including audio, video and/or emergency alert signals. According to an exemplary embodiment, decoder 26 decodes audio signals to thereby extract digitally encoded frequency shift keyed (FSK) signals, which represent emergency alert signals indicating an emergency event. According to another exemplary embodiment, decoder 27 decodes digital data which represents emergency alert signals indicating an emergency event. Decoder 27 may also perform other decoding functions, such as decoding data which represents emergency alert signals included in the vertical blanking interval (VBI) of an analog television signal.

According to an exemplary embodiment, the emergency alert signals include data comprising SAME data associated with the emergency event. SAME data comprises a digital code representing information such as the specific geographical area affected by the emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tornado watch, radiological hazard warning, civil emergency, etc.) which activate the emergency alert function.

When the emergency alert function of television signal receiver 20 is activated, processor 27 outputs one or more control signals which enable various operations. According to an exemplary embodiment, such control signals may enable a disabled audio output device associated with television signal receiver 20. Once the disabled audio output device is enabled, such control signals may enable an alert output via the audio output device, and further enable other alert outputs such as a visual output via television signal receiver 20 and/or an alert output via a secondary device, to thereby notify individuals of an emergency event. Such control signals may also enable other operations of television signal receiver 20, such as causing it to be switched from an off/standby mode to an on mode. Further details regarding these aspects of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

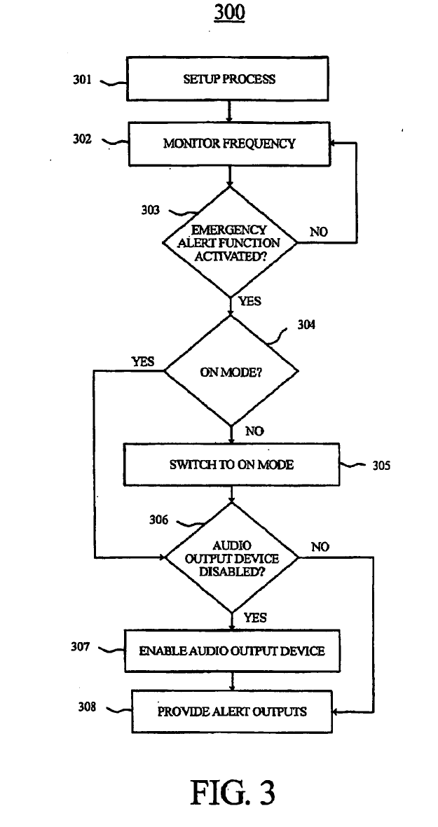

Turning now to FIG. 3, a flowchart 30 illustrating exemplary steps according to the present invention is shown. For purposes of example and explanation, the steps of FIG. 3 will be described with reference to television signal receiver 20 of FIG. 2. The steps of FIG. 3 are merely exemplary, and are not intended to limit the present invention in any manner.

At step 301, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 301:
A. Enable/Disable—The user may select whether to enable or disable the emergency alert function.
B. Frequency Selection—The user may select a frequency channel to be monitored in order to receive emergency alert signals. For example, the user may select a terrestrial, cable, satellite or other channel (e.g., NWS channel) which will be monitored for emergency alert signals. The selection of a monitoring channel may for example be facilitated through a frequency scanning operation which scans various frequency channels to thereby identify channels that provide the highest signal strength.
C. Geographical Areas—The user may select one or more geographical areas of interest. For example, the user may select a particular continent, country, region, state, area code, zip code, city, county, municipality, subdivision, and/or other definable geographical area. According to an exemplary embodiment, such geographical area(s) may be represented in memory 27 by location data, such as one or more Federal Information Processing Standard (FIPS) location codes.
D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.
E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. According to another exemplary embodiment, the user may also select to provide one or more alert outputs via secondary devices, such as a telephone, computer, or other device. Moreover, the alert outputs may be selected on an event-by-event basis. Other types of alert outputs may also be provided according to the present invention.

According to the present invention, other menu selections may also be provided at step 301 and/or some of the menu selections described above may be omitted. Data corresponding to the user's selections during the setup process of step 301 is stored in memory 27.

At step 302, television signal receiver 20 monitors the frequency channel selected by the user during the setup process of step 301 (i.e., item B) for emergency alert signals. According to an exemplary embodiment, tuner 22 monitors the selected frequency channel and thereby receives incoming emergency alert signals. According to the present invention, television signal receiver 20 is capable of monitoring a frequency channel and receiving emergency alert signals during all modes of operation, including for example when television signal receiver 20 is turned on, turned off, and/or during playback of recorded audio and/or video content.

At step 303, a determination is made as to whether the emergency alert function of television signal receiver 20 is activated. According to an exemplary embodiment, processor 27 makes this determination by comparing data included in the incoming emergency alert signals to data stored in memory 27. As previously indicated herein, the emergency alert signals may include data such as SAME data which represents information including the type of emergency event (e.g., tornado watch, radiological hazard warning, civil emergency, etc.) and the specific geographical area(s) affected by the emergency event. According to an exemplary embodiment, processor 27 compares this SAME data to corresponding user setup data (i.e., items C and D of step 301) stored in memory 27 to thereby determine whether the emergency alert function is activated. In this manner, the emergency alert function of television signal receiver 20 is activated when the emergency event indicated by the emergency alert signals corresponds to: (1) the geographical area(s) selected by the user for item C of step 301 and (2) the event type(s) selected by the user for item D of step 301.

If the determination at step 303 is negative, process flow loops back to step 302 where tuner 22 continues to monitor the selected frequency channel. Alternatively, if the determination at step 303 is positive, process flow advances to step 304 where processor 27 determines whether television signal receiver 20 is in the on mode (i.e., turned on). If the determination at step 304 is negative, process flow advances to step 305 where processor 27 outputs one or more control signals to switch television signal receiver 20 from the off/standby mode to the on mode.

If the determination at step 304 is positive or following step 305, process flow advances to step 306 where processor 27 determines whether an audio output device associated with television signal receiver 20 is disabled. According to an exemplary embodiment, the audio output device associated with television signal receiver 20 at step 306 includes an internal speaker such as speaker 25. According to another exemplary embodiment, the audio output device associated with television signal receiver 20 at step 306 includes an audio output device such as an audio receiver and/or amplifier which is operatively connected to television signal receiver 20. As previously indicated herein, the aforementioned audio output devices may be disabled from providing alert outputs in certain instances. For example, an internal speaker of television signal receiver 20 such as speaker 25 may be disabled when another audio output device such as an audio receiver and/or amplifier is operatively connected to an audio output terminal (e.g., audio output plug(s)) of television signal receiver 20. Moreover, the connected audio output device may not be turned on, or may be turned on but processing audio data from an input source other than television signal receiver 20 such as a VCR, DVD player, or other device. In such an instance, these audio output devices may be disabled from providing alert outputs.

If the determination at step 306 is negative, process flow advances to step 308 which will be described later herein. Alternatively, if the determination at step 306 is positive, process flow advances to step 307 where the disabled audio output device is enabled. According to an exemplary embodiment, processor 27 outputs one or more control signals to audio amplifier 24 at step 307 to thereby enable an internal speaker of television signal receiver 20 such as speaker 25. With this exemplary embodiment, processor 27 also outputs one or more control signals to disable and thereby mute other audio sources associated with television signal receiver 20, such as audio from an audio output device connected to an audio output terminal, audio from tuner 22, audio from an integrated device (e.g., DVD player, VCR, etc.) and/or other audio sources. Disabling such audio sources prevents the combination of more than one audio feed which may cause individuals to miss an aural alert output provided via the internal speaker (e.g., speaker 25) of television signal receiver 20 due to noise.

According to another exemplary embodiment, processor 27 outputs one or more control signals at step 307 to enable an audio output device such as an audio receiver and/or amplifier which is operatively connected to an audio output terminal of television signal receiver 20. For example, processor 27 may output one or more control signals which cause an infrared (IR) or other transmitter (not shown) associated with television signal receiver 20 to transmit control signals which turn on the connected audio output device and/or cause the connected audio output device to switch its input source to television signal receiver 20. In this manner, aural alert outputs may be provided via the audio output device which is operatively connected to television signal receiver 20.

At step 308, television signal receiver 20 provides one or more alert outputs to thereby notify individuals of the emergency event which activated the emergency alert function. According to an exemplary embodiment, processor 27 enables the one or more alert outputs at step 308 in accordance with the user's selections during the setup process of step 301 (i.e., item E), and such alert outputs may be aural and/or visual in nature. For example, aural outputs such as a warning tone, an NWS audio message, and/or other audio content may be provided at step 308 via an internal speaker of television signal receiver 20 such as speaker 25, or via an audio output device which is operatively connected to an audio output terminal of television signal receiver 20. The volume of such aural outputs may be controlled in accordance with the volume level set by the user during the setup process of step 301. Visual outputs may also be provided at step 308 via display 29 to notify individuals of the emergency event. According to an exemplary embodiment, an auxiliary information display such as an NWS text message (e.g., as a closed caption display) and/or a video output from a specific channel may be provided at step 308 via display 29 under the control of processor 27. Such aural and/or visual outputs may also be controlled by a user via a control device associated with television signal receiver 20, such as a hand-held remote control device. For example, a user may press a key on the remote control device to restore an internal speaker of television signal receiver 20 to its prior disabled state, and enable an audio output device which is connected to television signal receiver 20. A user may also perform other control functions such as turning alert outputs on and off.

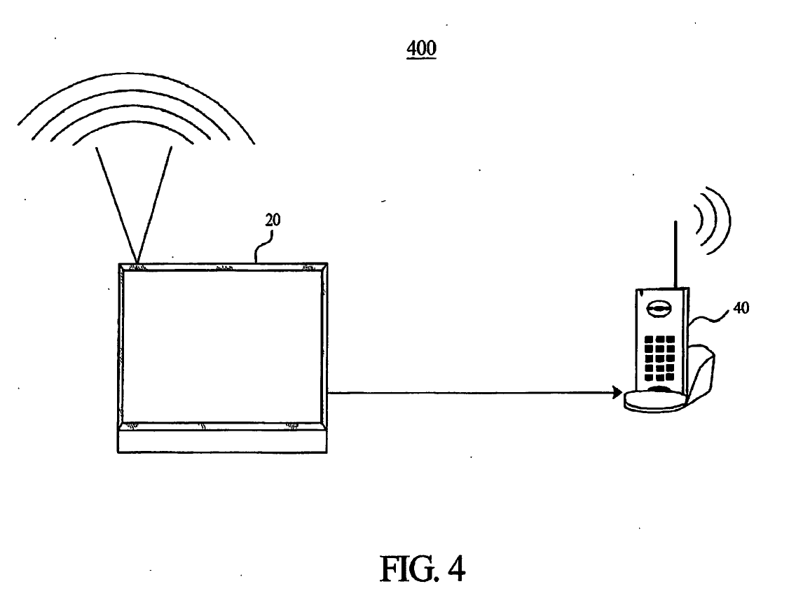

According to an exemplary embodiment, the alert output(s) provided at step 308 may also be provided via one or more secondary devices. FIGS. 4 through 7 illustrate how alert outputs may be provided via secondary devices according to exemplary embodiments of the present invention. Details such as, but not limited to, which secondary devices provide an alert output, which emergency events (if any) trigger a particular secondary device, and the manner in which alert outputs are provided by a particular secondary device may be specified by a user during the setup process of step 301.

In the exemplary embodiment of FIG. 4, television signal receiver 20 may be programmed to activate a dialing function of a telephone 40 when the emergency alert function of television signal receiver 20 is activated for certain emergency events. Telephone 40 may be a stand-alone device separate from television signal receiver 20 as shown in FIG. 4, or may be embodied within the chassis of television signal receiver 20. With the embodiment of FIG. 4, television signal receiver 20 may transmit control signals to telephone 40 using a wired and/or wireless connection when the emergency alert function is activated for certain emergency events. Such control signals may activate the dialing function of telephone 40, thereby causing telephone 40 to dial one or more predetermined phone numbers. The number or numbers to be dialed by telephone 40 upon activation of the emergency alert function may be programmed via television signal receiver 20 (e.g., during step 301) and/or telephone 40. After the dialing function of telephone 40 is activated, television signal receiver 20 may transmit alert output signals representing, for example, an audio and/or textual message to telephone 40 which in turn provides the message to a receiver of the call. Telephone 40 may also be programmed to provide a predetermined message to the receiver of the call upon receipt of alert output signals from television signal receiver 20.

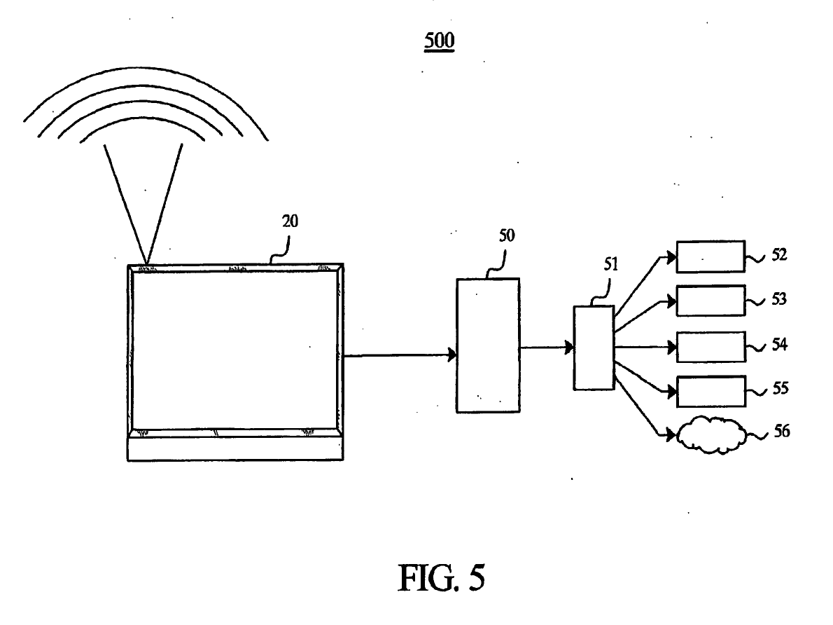

In the exemplary embodiment of FIG. 5, television signal receiver 20 may be programmed to provide an alert output via secondary devices connected to it via a wired and/or wireless network such as a local area network (LAN), wide area network (WAN), and/or the internet. As indicated in FIG. 5, television signal receiver 20 may transmit alert output signals to a server/computer 50 when the emergency alert function of television signal receiver 20 is activated. Server/computer 50 may then provide the alert output signals to a router 51, which in turn provides the alert output signals to network devices 52 to 55, which may be embodied as computers. Router 51 may also provide the alert output signals to another network 56, such as another LAN, WAN and/or the internet. With the exemplary embodiment of FIG. 5, the manner in which the alert outputs are provided may be specified by a user during the setup process of step 301. For example, a user may specify items such as: which devices on the network receive the alert output signals, whether all devices receive the alert output signals at the same time or in a certain sequence depending, for example, upon the severity of the emergency event, and/or other items.

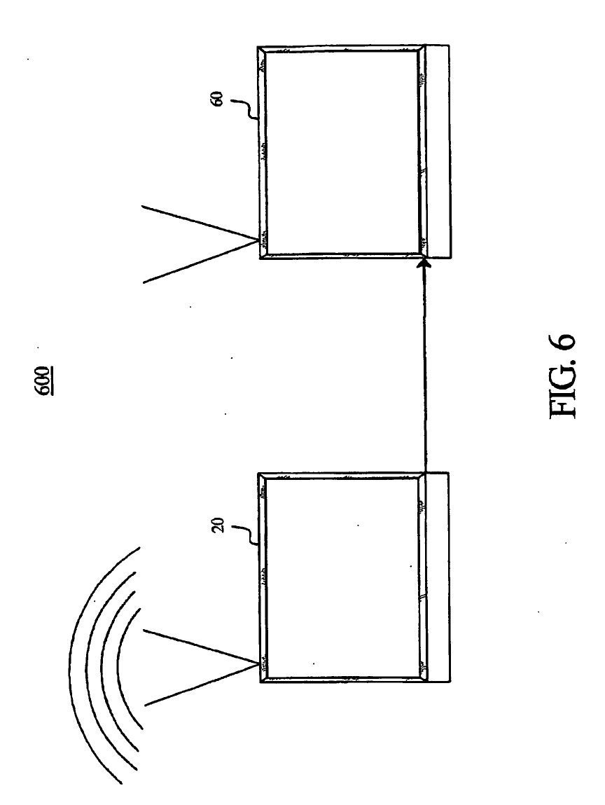

In the exemplary embodiment of FIG. 6, television signal receiver 20 may be programmed to provide an alert output to a secondary device such as television signal receiver 60 via a wired and/or wireless connection. For example, television signal receiver 20 may transmit IR control signals to television signal receiver 60 when the emergency alert function of television signal receiver 20 is activated. Such IR control signals may control functions of television signal receiver 60 such as switching it to the on mode, channel tuning, audio volume control, switching it to the off/standby mode after a predetermined time period and/or other functions. With the exemplary embodiment of FIG. 6, another device having an emergency alert function such as a radio may be used in substitution of television signal receiver 20 as the primary alerting device.

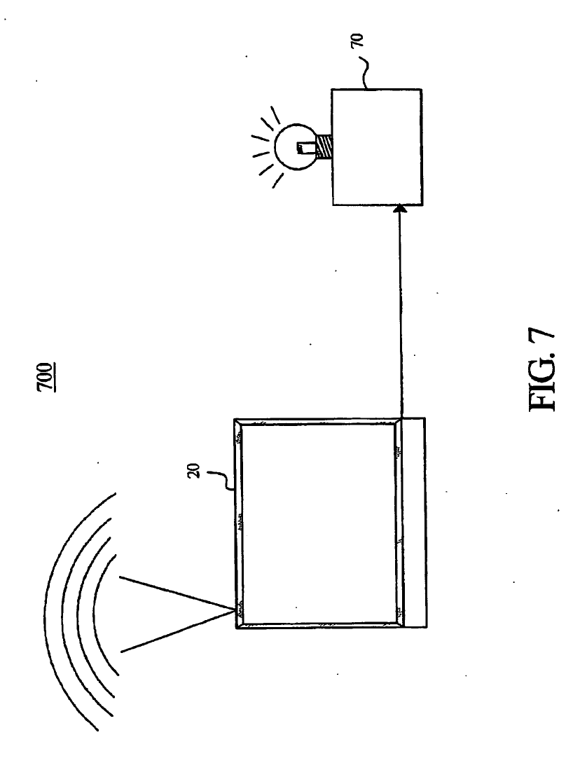

In the exemplary embodiment of FIG. 7, television signal receiver 20 may be programmed to provide an alert output to a secondary device such as visual output device 70 via a wired and/or wireless connection. Visual output device 70 may be embodied as any device capable of providing a visual alert output, such as a flashing light and/or other device. The embodiment of FIG. 7 may be useful for hearing impaired users, environments having high-ambient noise, and/or when a user is far away from television signal receiver 20. Other types of secondary devices than those expressly shown in FIGS. 4 to 7, such as pagers, may also be used according to the present invention.

The principles of the present invention described herein may also be applied to a wake-up timer or schedule/watch timer feature of television signal receiver 20. For example, if television signal receiver 20 is programmed to switch to the on mode (i.e., turn on) at a predetermined time to wake up a user, an audio output device (e.g., internal speaker, etc.) associated with television signal receiver 20 may be disabled if another audio output device such as an audio receiver and/or amplifier is connected to an audio output terminal of television signal receiver 20. Moreover, the connected audio output device may not be turned on, or may be turned on but processing audio data from an input source other than television signal receiver 20. In such an instance, the audio output device (e.g., internal speaker, etc.) associated with television signal receiver 20 may be enabled when the user presses a predetermined key on a remote control device. An on-screen message may also remind the user to turn on the connected audio output device if he hasn't done so already.

As described herein, the present invention provides, among other things, apparatuses for providing alert outputs which increase the likelihood that users are promptly notified of emergency events. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, VCRs, DVD players, video game boxes, personal video recorders (PVRs), computers or other apparatuses that may not include a display device. The present invention may also be applied to radios. Moreover, the present invention is applicable to television signal receivers having a single audio output terminal which may be switched between a fixed volume output and a variable volume output, and is also applicable to television signal receivers having both a fixed volume audio output terminal and a variable volume audio output s terminal.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus having an emergency alert function, comprising:
tuning means for tuning signals including emergency alert signals capable of activating said emergency alert function; and
processing means for enabling a disabled audio output device associated with said apparatus responsive to activation of said emergency alert function.

2. The apparatus of claim 1, wherein said disabled audio output device includes an internal speaker of said apparatus.

3. The apparatus of claim 1, wherein said disabled audio output device is operatively connected to an audio output terminal of said apparatus.

4. The apparatus of claim 1, wherein said processing means further enables a first alert output via said audio output device responsive to activation of said emergency alert function.

5. The apparatus of claim 4, wherein said processing means further enables a second alert output via a secondary device responsive to activation of said emergency alert function.

6. The apparatus of claim 5, wherein said secondary device includes a telephone.

7. The apparatus of claim 5, wherein said secondary device includes a computer.

8. The apparatus of claim 5, wherein said secondary device includes a television signal receiver.

9. The apparatus of claim 5, wherein said secondary device includes a visual output device.

10. A method for controlling an apparatus having an emergency alert function, comprising:
tuning signals including emergency alert signals capable of activating said emergency alert function; and
enabling a disabled audio output device associated with said apparatus responsive to activation of said emergency alert function.

11. The method of claim 10, wherein said disabled audio output device includes an internal speaker of said apparatus.

12. The method of claim 10, wherein said disabled audio output device is operatively connected to an audio output terminal of said apparatus.

13. The method of claim 10, further comprised of enabling a first alert output via said audio output device responsive to activation of said emergency alert function.

14. The method of claim 13, further comprised of enabling a second alert output via a secondary device responsive to activation of said emergency alert function.

15. The method of claim 14, wherein said secondary device includes a telephone.

16. The method of claim 14, wherein said secondary device includes a computer.

17. The method of claim 14, wherein said secondary device includes a television signal receiver.

18. The method of claim 14, wherein said secondary device includes a visual output device.

19. A television signal receiver having an emergency alert function, comprising:
a tuner operative to tune signals including emergency alert signals capable of activating said emergency alert function; and
a processor operative to enable a disabled audio output device associated with said television signal receiver responsive to activation of said emergency alert function.

20. The television signal receiver of claim 19, wherein said disabled audio output device includes an internal speaker of said television signal receiver.

21. The television signal receiver of claim 19, wherein said disabled audio output device is operatively connected to an audio output terminal of said television signal receiver.

22. The television signal receiver of claim 19, wherein said processor is further operative to enable a first alert output via said audio output device responsive to activation of said emergency alert function.

23. The television signal receiver of claim 22, wherein said processor is further operative to enable a second alert output via a secondary device responsive to activation of said emergency alert function.

24. The television signal receiver of claim 23, wherein said secondary device includes a telephone.

25. The television signal receiver of claim 23, wherein said secondary device includes a computer.

26. The television signal receiver of claim 23, wherein said secondary device includes a television signal receiver.

27. The television signal receiver of claim 23, wherein said secondary device includes a visual output device.
